(19) United States
(12) Patent Application Publication
(10) Pub. No.: US 2006/0034735 A1
(43) Pub. Date: Feb. 16, 2006

(54) Microreactor

(75) Inventors: Akira Miura, Tokyo (JP); Morio Wada, Tokyo (JP); Tsuyoshi Yakihara, Tokyo (JP); Shinji Kobayashi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION

(21) Appl. No.: 11/199,366

(22) Filed: Aug. 9, 2005

(30) Foreign Application Priority Data
Aug. 10, 2004 (JP) P. 2004-232882

(51) Int. Cl. B06B 1/00; B32B 27/04

(52) U.S. Cl. 422/128; 422/127

(57) ABSTRACT

A microreactor has a plurality of flow channels and a joint flow channel where the plurality of flow channels are joined. Fluids flowing through the plurality of flow channels join in the joint flow channel to react with each other. The microreactor further has an ultrasonic wave oscillation section which applies an ultrasonic wave to the joint flow channel.

### CROSS-REFERENCE TO RELATED APPLICATIONS

This application is based upon and claims the benefit of priority from the prior Japanese Patent Applications No. 2004-232882, filed on Aug. 10, 2004, the entire contents of which are incorporated herein by reference.

### BACKGROUND OF THE INVENTION

1. Field of the Invention

In recent years, researches on controlling creation of super molecules making the most of a photocalytic chemical reaction and a photo-enzyme chemical reaction using laser light and separation and purification of biochemical substances of an enzyme, a protein, etc., using a photoreaction have advanced. Application to state analysis such as spectral analysis using plasma generated by laser light has also advanced. The invention relates to a microreactor as a reaction vessel used in such a field.

2. Description of the Related Art

The microreactor is a very small-sized reaction vessel and is formed of a substance whose physico-chemical characteristic is clear, such as silicon, crystal, polymer, or metal; generally it is worked to a length of several cm with the flow channel of a fluid measuring about 10 to 100 μm in diameter using micromachining technology of microelectronics, micromachine (MEMS), etc.

If a vessel for causing a biochemical reaction is micro-sized, a peculiar effect appears in a minute space. As the scale effect of a micromachine, blending is promoted and a reaction easily occurs because of dispersion of molecules without blending a reaction liquid due to an increase in the ratio of surface to volume accompanying the microsizing. That is, if the scale is small, a laminar-dominated flow results; if the dispersion length is shortened, blending in a short time is possible.

The following documents are known as related arts of such a microreactor.

[Document 1] FUJII Teruhito: “Shuusekigata microreactor chip,” Nagare vol. 20 No. 2 (published in April 2001), pp. 99-105

[Document 2] SOTOWA Kenichirou, KUSAKABE Katsumi: “Microreactor de kiwameru CFD,” Fluent Asian Pacific News Letter Fall (2002)

[Document 3] JP-A-2003-126686

FIGS. 2A and 2B show the configuration of a microreactor described in documents 1 and 2, wherein two liquids are allowed to flow into a joint flow channel where flow channels are joined as shaped like a letter Y, and reaction of the two liquids is caused. FIG. 2A is a plan view and FIG. 2B is a sectional view taken on line A-A in FIG. 2A.

In FIGS. 2A and 2B, numeral 10 denotes a first substrate (PDMS resin (Poly-dimethyloxane)) formed with a groove 11, which is made up of a first flow channel 11a, a second flow channel 11b, and a joint flow channel 11c. Numeral 12a denotes a first inflow port formed at an end part of the first flow channel 11a, numeral 12b denotes a second inflow port formed at an end part of the second flow channel 11b, and numeral 13 denotes an outflow port formed at an end part of the joint flow channel 11c. Numeral 14 denotes a second substrate (PMMA (Methacrylic resin)), which is fixed covering the side where the groove of the first substrate 10 is formed. The cross section of the groove of the microreactor is about 100 μm².

FIG. 2C shows a state in which fluids different in component flowing through the first and second flow channels 11a and 11b join in the joint flow channel; since the scale is small, a laminar-dominated flow results. Thus, within the flow channel of microscale, mostly the Reynolds number is smaller than one; it can be used for performing extraction operation between the two types of liquid phases, etc., for example. Although the state is the laminar state, if the flow width is lessened (the dispersion length is shortened), blending can be executed in a short time.

FIGS. 3A to 3C are plan views to show the configuration of a microreactor described in document 3. Parts similar to those previously described with reference to FIGS. 2A to 2C are denoted by the same reference numerals in FIGS. 3A to 3C.

In FIG. 3A, a notch 23 is formed in the vicinity of the joint point where first and second flow channels join, and a partition wall from the bottom to a joint flow channel 11c measures about 10 μm in thickness and the heating range is about 100 μm. Numeral 20 denotes laser light narrowed through a lens. In this example, SUS, aluminum, glass, etc., is used as the material of a first substrate 10.

FIGS. 3B and 3C show examples wherein the first substrate 10 is formed of an optically transparent material of glass, transparent plastic, etc., and is used to directly form a convex lens and a Fresnel lens. Also in this case, laser light is applied through the convex lens and the Fresnel lens for heating and promoting a chemical reaction of fluid flowing through the joint flow channel.

By the way, the microreactor using the microflow channel in the related art shown in FIGS. 2A to 2C is intended for reaction based on dispersion of molecules by joining the flow channels, and the microreactor shown in FIGS. 3A to 3C is intended for controlling the temperature, etc., by a laser for promoting the chemical reaction of fluid flowing through the joint flow channel.

However, only limited chemical reactions can be obtained simply by heating depending on the type of fluid.

### SUMMARY OF THE INVENTION

An object of the invention is to provide a microreactor provided with a mechanism which applies an ultrasonic wave to a joint flow channel so as to separate and concentrate a reaction product.

The invention provides a microreactor, including a plurality of flow channels and a joint flow channel where the plurality of flow channels are joined, in which fluids flowing through the plurality of flow channels join in the joint flow channel to react with each other, wherein the microreactor further includes an ultrasonic wave oscillation section which applies an ultrasonic wave to the joint flow channel.

In the microreactor, the ultrasonic wave oscillation section is disposed on a side face of the joint flow channel.

In the microreactor, strength of the ultrasonic wave applied by the ultrasonic wave oscillation section is variable.

In the microreactor, the ultrasonic wave oscillation section is disposed so as to apply the ultrasonic wave at right angles to the fluids flowing through the joint flow channel.

In the microreactor, the joint flow channel is branched into a plurality of channels on a downstream side.

According to the microreactor, it is possible to promote a specific chemical reaction, and separate and concentrate a specific reaction production substance that are impossible in the method using blending and chemical reaction by dispersion in a microflow channel controlling the temperature, pressure, etc., of the microflow channel in the related art.

### BRIEF DESCRIPTION OF THE DRAWINGS

FIG. 1 is a drawing to show an embodiment of a microreactor of the invention;

FIGS. 2A to 2C are schematic representation of a microreactor in a related art; and

FIGS. 3A to 3C are schematic representation of a microreactor in a related art.

### DETAILED DESCRIPTION OF THE PREFERRED EMBODIMENTS

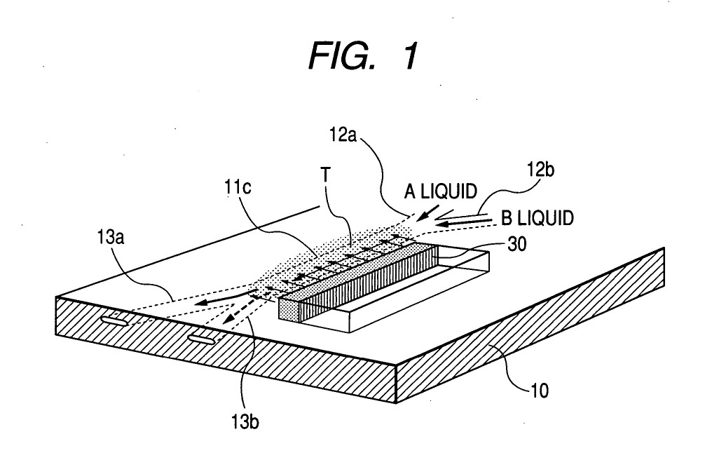

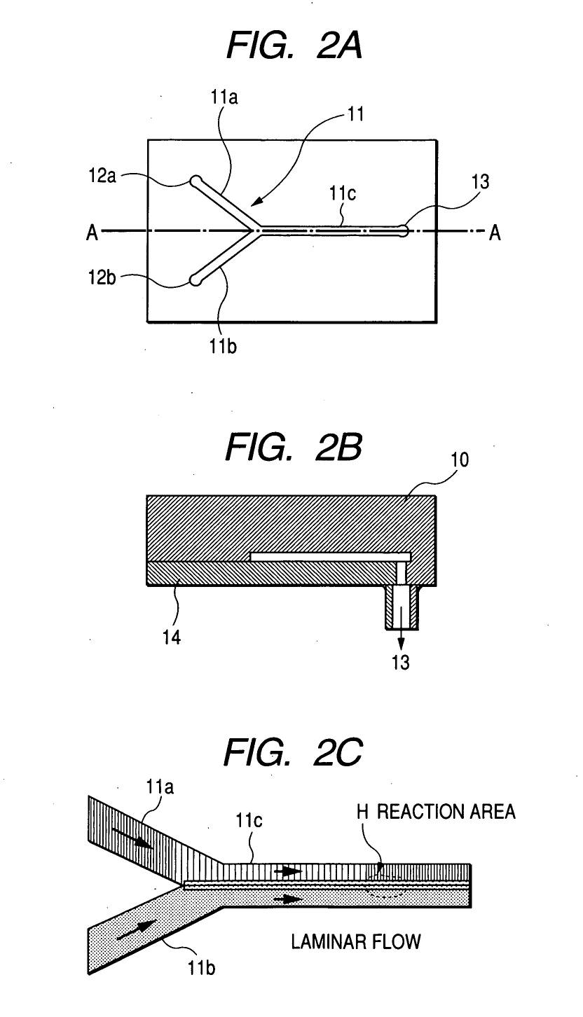

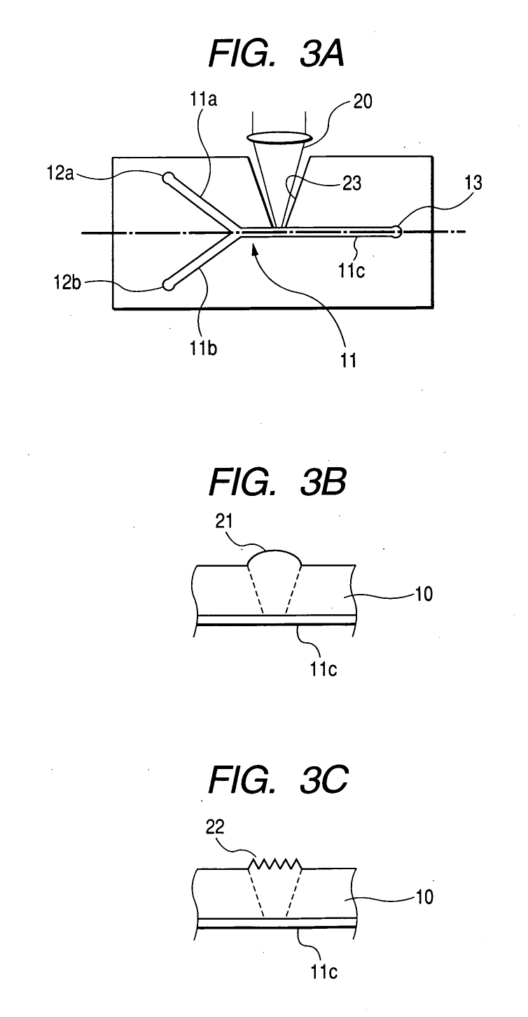

FIG. 1 shows an embodiment of the invention. Parts similar to those previously described with reference to FIGS. 2A to 2C and FIGS. 3A to 3C are denoted by the same reference numerals in FIG. 1.

In FIG. 1, A liquid flows into a reactor from a first inflow port 12a, and B liquid flows into the reactor from a second inflow port 12b. These liquids join in a joint flow channel 11c and flow out through outflow ports 13a and 13b.

Although not shown, a second substrate similar to that previously described with reference to FIGS. 2A to 2C in the related art example is formed on the side where the joint flow channel 11c of a first substrate 10 is formed, and covers the inflow ports 12a and 12b and the outflow ports 13a and 13b.

Numeral 30 denotes an ultrasonic wave oscillation element disposed along the joint flow channel 11c for applying an ultrasonic wave T in a direction at right angles to the flow direction of the A liquid and the B liquid flowing through the joint flow channel 11c. The strength of the ultrasonic wave applied by the ultrasonic wave oscillation element 30 can be adjusted by control means (not shown) of the ultrasonic wave oscillation element. It is assumed that the length of the ultrasonic wave oscillation element 30 and the distance to a side wall of the joint flow channel 11c are designed to become optimum.

According to such an ultrasonic reactor, the ultrasonic wave oscillation element 30 is disposed so as to apply an ultrasonic wave to the joint flow channel 11c through which the liquids to which the ultrasonic wave is applied pass, and the ultrasonic wave can be applied to the molecules of the liquids flowing through the joint flow channel 11c.

In the described configuration, if the ultrasonic wave of a specific wavelength resonates and disperses relative to a specific molecule flowing through the joint flow channel 11c, the molecule receives a force in a direction away from the ultrasonic wave oscillation element 30, and a concentration difference occurs in a direction perpendicular to the flow direction in the joint flow channel 11c (traveling wave direction of ultrasonic wave).

If the flow channel is branched for diverting the flow after the channel through the joint flow channel 11c, it is made possible to concentrate and separate a specific molecule. The resonating and dispersing molecule can be changed by changing the frequency of an ultrasonic wave. For the resonance and dispersion, it is also possible to dissolve so as to cut only the molecular chain of a specific molecule by enhancing the strength of the ultrasonic wave.

If a minute bubble is produced by applying an ultrasonic wave at the dispersing and blending time in the joint flow channel 11c as in the embodiment shown in FIG. 1, blending and reaction production can also be promoted. Particularly, a phenomenon in which a minute bubble occurs and disappears by applying an ultrasonic wave occurs in a reaction filed where the ultrasonic wave is applied. Thus, an ultimate environment at a pressure of several thousand atmospheres and at several ten thousand degrees occurs in the joint flow channel 11c, and a reactor in a high-energy state involving radical production, etc., can be easily created.

The liquids dissolved, caused to react, and blended by applying an ultrasonic wave can also be separated and concentrated as the later stage of the flow channel is branched.

The above embodiment of the invention described above is only illustrative for the description of the invention. In the embodiment, an ultrasonic wave is applied to two liquids flowing through the joint flow channel, but it is also possible to promote reaction and perform photoexcitation ionization by applying light of a specific wavelength.

Electric field applying means can also be provided in the joint flow channel for separating and concentrating by applying an electric field, and a magnetic field can also be applied in response to the type of reaction production substance.

In the description of the embodiment, two inflow ports and two outflow ports are provided by way of example, but more than two inflow ports or more than two outflow ports may be provided.

Therefore, it is to be understood that the invention is not limited to the above embodiment and that the invention includes various changes and modifications without departing from the spirit and scope of the invention.

What is claimed is:

1. A microreactor, comprising a plurality of flow channels and a joint flow channel where the plurality of flow channels are joined, in which fluids flowing through the plurality of flow channels join in the joint flow channel to react with each other,
wherein the microreactor further comprises an ultrasonic wave oscillation section which applies an ultrasonic wave to the joint flow channel.

2. The microreactor according to claim 1,
wherein the ultrasonic wave oscillation section is disposed on a side face of the joint flow channel.

3. The microreactor according to claim 1,
wherein strength of the ultrasonic wave applied by the ultrasonic wave oscillation section is variable.

4. The microreactor according to claim 1,
wherein the ultrasonic wave oscillation section is disposed so as to apply the ultrasonic wave at right angles to the fluids flowing through the joint flow channel.

5. The microreactor according to claim 1,
wherein the joint flow channel is branched into a plurality of channels on a downstream side.
